(19) United States
(12) Patent Application Publication
(10) Pub. No.: US 2012/0075172 A1
(43) Pub. Date: Mar. 29, 2012

(54) LIQUID CRYSTAL DISPLAY DEVICE

(75) Inventor: Tatsuo Makishima, Tokyo (JP)

(73) Assignees: Panasonic Liquid Crystal Display Co., Ltd.; Hitachi Displays, Ltd.

(21) Appl. No.: 13/239,896

(22) Filed: Sep. 22, 2011

(30) Foreign Application Priority Data
Sep. 28, 2010 (JP) 2010-217796

(51) Int. Cl. G09G 3/36

(52) U.S. Cl. 345/92

(57) ABSTRACT

The present invention provides a liquid crystal display device having a large screen, high resolution and high reliability at the same time, even in the case where the drivers are mounted on the TFT substrate in accordance with a COG mounting method.

### CROSS-REFERENCE TO RELATED APPLICATION

The present application claims priority over Japanese Application JP2010-217796 filed on Sep. 28, 2010, the contents of which are hereby incorporated into this application by reference.

### BACKGROUND OF THE INVENTION

(1) Field of the Invention

The present invention relates to a liquid crystal display device, and in particular to a liquid crystal display device where semiconductor chips are mounted on a substrate.

(2) Description of the Related Art

Liquid crystal display devices are used as an image displaying means. In recent years, liquid crystal display devices have also been used in a car panel or as a monitor in a car. In some cases, the liquid crystal display devices for cars are used in an environment where the temperature is higher than in the environment where conventional liquid crystal televisions, displays for cellular phones and monitors for personal computers are used. Accordingly, the liquid crystal display devices for cars are required to have an operational guarantee for a high ambient temperature (for example, approximately 85° C.) in comparison with liquid crystal televisions, displays for cellular phones and monitors for personal computers. Furthermore, the liquid crystal display devices for cars are required to have higher reliability in terms of vibration and impact. Therefore, a so-called COG (chip on glass) mounting method according to which drivers are directly mounted on a glass substrate is more preferable than the COF (chip on film) mounting method in order to mount drivers (semiconductor chips) on a liquid crystal display panel. This is because the substrate and the film that are connected by applying pressure in accordance with the COF mounting method have low durability against high temperatures, vibration or impact, and thus the possibility of the film being peeled off from the substrate at a high temperature or due to a strong vibration or impact is high. In particular, it has become essential to use the COG mounting method for the drivers for processing video signals (may be referred to as source drivers or drain drivers).

Meanwhile, liquid crystal display devices for cars, such as car navigation systems, have mainly been used for an instrument panel (dashboard), and seven inches has been the maximum screen size. Recently, the demand on an increase in the size of the screen of the display device (for example, 17 inches) or on an increase in the resolution has been increasing together with the diversification of the video contents that are viewed in a car and a desire that the display device be used as a personal computer.

In order to implement a liquid crystal display device for a car having a large screen, high resolution and high reliability at the same time in accordance with a COG mounting method, it is necessary to take heat emissions from the drivers into consideration. In particular, the driving load of source drivers increases as the driving frequency increases due to an increase in the operational speed for a larger screen and an increase in the resolution, and therefore heat emissions from the source drivers have become so large that they cannot be ignored. Therefore, the method for releasing heat from source drivers has become an important issue.

FIG. 1 is a plan diagram showing a liquid crystal display device using a conventional TFT substrate, FIG. 2 is a cross-sectional diagram along single-dotted chain line X1-X2 in FIG. 1, and FIG. 3 is a cross-sectional diagram along single-dotted chain line Y1-Y2 in FIG. 1. The source drivers and the drivers for processing scanning signals (gate drivers) are mounted on the TFT substrate where TFTs are formed in accordance with a COG mounting method. The TFT substrate is placed on a frame for supporting the backlight with spacers in between. As shown in FIGS. 2 and 3, the source drivers and the gate drivers are mounted in such locations as to face the spacers with the TFT substrate in between. The spacers are formed of a relatively soft foam insulator in order to make the TFT substrate and the frame make stable and close contact with each other and to prevent the TFT substrate from deforming. Light emitting diodes (LEDs) are used for the light source for the backlight, and a number of light emitting diodes (light emitting elements) are aligned directly beneath the locations where the source drivers are placed on the TFT substrate. The backlight is formed of a light guiding plate for spreading the light from the LEDs throughout the entirety of the liquid crystal display region and an optical sheet (not shown) for dispersing or collecting illumination light towards the liquid crystal display panel side, which is located between the TFT substrate and the light guiding plate.

In the conventional liquid crystal display device shown in FIGS. 1 to 3, the LEDs and the source drivers emit heat. Here, the gate drivers are slow in the operational speed and barely emit any heat. As shown in FIG. 2, the LEDs and the source drivers face each other, but the heat from the LEDs is shielded by the spacers, which are foam insulators, and therefore the heat from the LEDs is barely conveyed to the source driver side. Accordingly, the temperature of the source driver can be within the acceptable range if the heat emissions from the source drivers are suppressed to such a degree so as not to cause a problem by adjusting the screen size and the operational conditions, such as driving frequency.

In the case where the screen has become large and is driven with high resolution, however, heat emission is great due to an increase in the load of the source drivers. According to the trial test calculations, heat emission from the source drivers increases the temperature of a screen having a size of approximately 17 inches by 20° C. to 25° C., and it is expected that the temperature increases in proportion with the size of the screen in the case where the screen size is further increased. Therefore, it is possible for the temperature of the drivers to exceed the standard value (temperature where the operation of the drivers is guaranteed, approximately 110° C. to 115° C.) in the case where heat emission from the drivers is applied to the ambient temperature when the ambient temperature is 85° C., at which the operational guarantee is required in the market. Thus, there is almost no margin for the temperature at which the operation should be guaranteed when the screen is large and driven with high resolution, and as a result there is a concern that the reliability in the liquid crystal display devices for cars may be lowered.

### SUMMARY OF THE INVENTION

An object of the present invention is to solve the above described problem and to provide a liquid crystal display device having a large screen, high resolution and high reliability at the same time, even in the case where the drivers are mounted on the TFT substrate in accordance with a COG mounting method.

In order to achieve the above-described object, the following means are available.

(1) A liquid crystal display device, having: a TFT substrate where thin film transistors are formed; a counter substrate that faces said TFT substrate; a liquid crystal display panel where liquid crystal is sealed between said TFT substrate and said counter substrate; a backlight which illuminates said liquid crystal display panel with light; and a frame which supports said liquid crystal display panel, characterized in that scanning signal lines and video signal lines are formed on said TFT substrate, semiconductor chips connected to said video signal lines are provided to said TFT substrate, said semiconductor chips are placed along a first side of said TFT substrate, a first spacer is provided in a location that faces said semiconductor chip as viewed in a plane between said first side of said TFT substrate and said frame, and a second spacer of which a thermal conductance is lower than said first spacer is provided between said frame and a second side of said TFT substrate, the second side being different from said first side.
(2) The liquid crystal display device according to the above (1), characterized in that the thermal conductance of said first spacer is 0.5 W/m·K or higher.
(3) The liquid crystal display device according to the above (1) or (2), characterized in that a material of said first spacer includes silicon or graphite.
(4) The liquid crystal display device according to any of the above (1) to (3), characterized in that said second spacer is formed of a foam insulator.
(5) The liquid crystal display device according to any of the above (1) to (4), characterized in that said backlight has light emitting elements and a light guiding plate, said light emitting elements are aligned along one side of said light guiding plate, and said one side of said light guiding plate faces said second side of said TFT substrate.
(6) The liquid crystal display device according to the above (5), characterized in that gate drivers connected to said scan signal lines are provided to said TFT substrate, and said gate drivers are aligned along a side of said TFT substrate that faces said one side of said light guiding plate.
(7) The liquid crystal display device according to the above (5), characterized in that said second side of said TFT substrate is parallel to said first side of said TFT substrate.
(8) The liquid crystal display device according to any of the above (5) to (7), characterized in that said light emitting elements are a number of light emitting diodes.
(9) A liquid crystal display device, having: a TFT substrate where thin film transistors are formed; a counter substrate that faces said TFT substrate; a liquid crystal display panel where liquid crystal is sealed between said TFT substrate and said counter substrate; a backlight which illuminates said liquid crystal display panel with light; and a frame which supports said liquid crystal display panel, characterized in that scanning signal lines and video signal lines are formed on said TFT substrate, semiconductor chips connected to said video signal lines are provided to said TFT substrate, spacers having a thermal conductance of 0.5 W/m·K or higher are provided between the sides of said TFT substrate and said frame, said semiconductor chips are aligned along a first side of said TFT substrate and face a spacer as viewed in a plane, said backlight has light emitting elements and a light guiding plate, said light emitting elements are aligned along one side of said light guiding plate, and said one side of said light guiding plate faces a second side of said TFT substrate, the second side being different from said first side.
(10) The liquid crystal display device according to the above (9), characterized in that a material of said spacers includes silicon or graphite.
(11) The liquid crystal display device according to the above (9) or (10), characterized in that gate drivers connected to said scanning signal lines are provided to said TFT substrate, and said gate drivers are aligned along a side of said TFT substrate that faces said one side of said light guiding plate.
(12) The liquid crystal display device according to any of the above (9) to (11), characterized in that said light emitting elements are a number of light emitting diodes.

According to the present invention, thermally conductive spacers are provided to the portions of a thin film transistor substrate that correspond to the portions on which semiconductor chips are mounted between the thin film transistor substrate and the frame for supporting the backlight, and therefore the heat emitted from the semiconductor chips can be released using the frame, and thus the temperature can be prevented from rising due to the semiconductor chips, even when the load on the semiconductor chips increases due to an increase in the size of the screen and an increase in the resolution. As a result, a liquid crystal display device having a large screen, high resolution and high reliability at the same time can be provided.

In addition, light emitting diodes are aligned along at least one side of the backlight, and the semiconductor chips and the light emitting diodes are not placed on the same side of the liquid crystal display panel in the configuration, and thus the heat emitted from the light emitting diodes and the heat emitted from the semiconductor chips do not merge, and thus the temperature can be prevented from increasing to a high temperature in a local place. This configuration can be applied to the semiconductor chips that are source drivers, and thus the reliability of the liquid crystal display device can further be increased.

### BRIEF DESCRIPTION OF THE DRAWINGS

FIG. 1 is a plan diagram showing a conventional liquid crystal display device;

FIG. 2 is a cross-sectional diagram along single-dotted chain line X1-X2 in FIG. 1;

FIG. 3 is a cross-sectional diagram along single-dotted chain line Y1-Y2 in FIG. 1;

FIG. 4 is a plan diagram illustrating the liquid crystal display device according to the first embodiment of the present invention;

FIG. 5 is a cross-sectional diagram along single-dotted chain line X1-X2 in FIG. 4;

FIG. 6 is a cross-sectional diagram along single-dotted chain line Y1-Y2 in FIG. 4;

FIG. 7 is a plan diagram illustrating the liquid crystal display device according to the first embodiment of the present invention;

FIG. 8 a cross-sectional diagram along single-dotted chain line X1-X2 in FIG. 7;

FIG. 9 is a cross-sectional diagram along single-dotted chain line Y1-Y2 in FIG. 7;

FIG. 10 is a plan diagram illustrating the liquid crystal display device according to the first embodiment of the present invention;

FIG. 11 a cross-sectional diagram along single-dotted chain line X1-X2 in FIG. 10; and

FIG. 12 is a cross-sectional diagram along single-dotted chain line Y1-Y2 in FIG. 10.

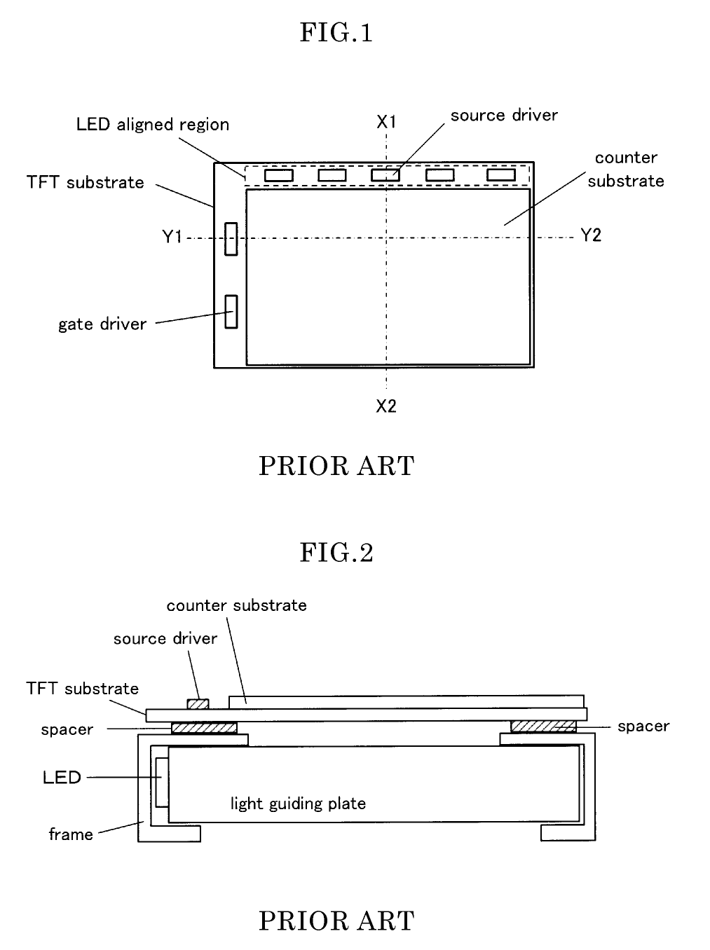

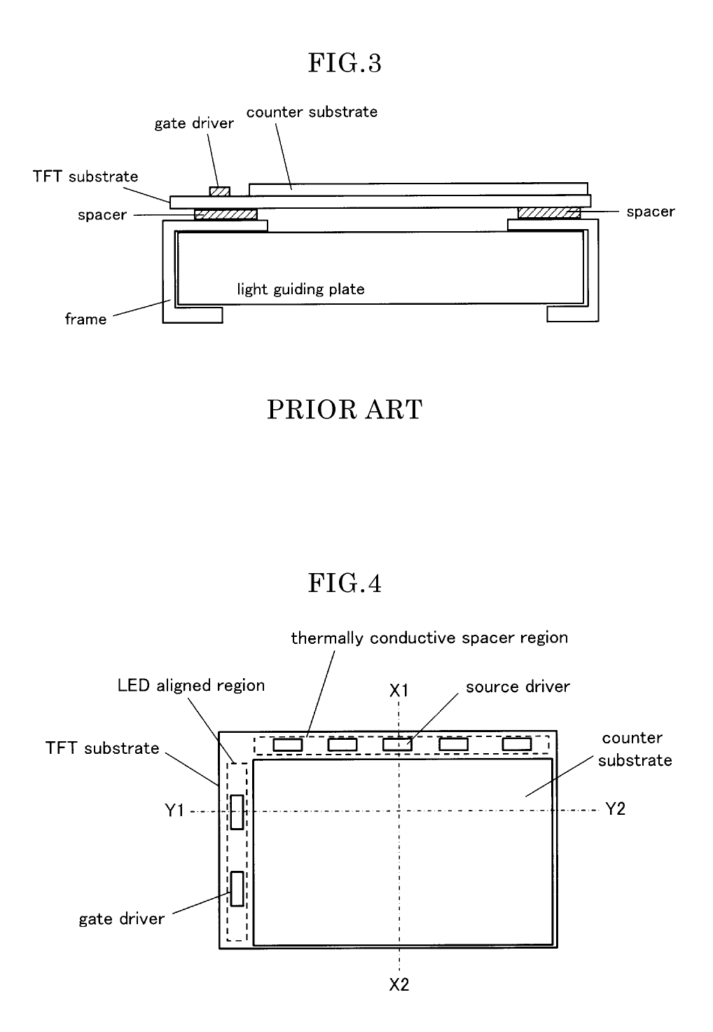

### DESCRIPTION OF THE EMBODIMENTS

The liquid crystal display device according to the present invention is described in detail below.

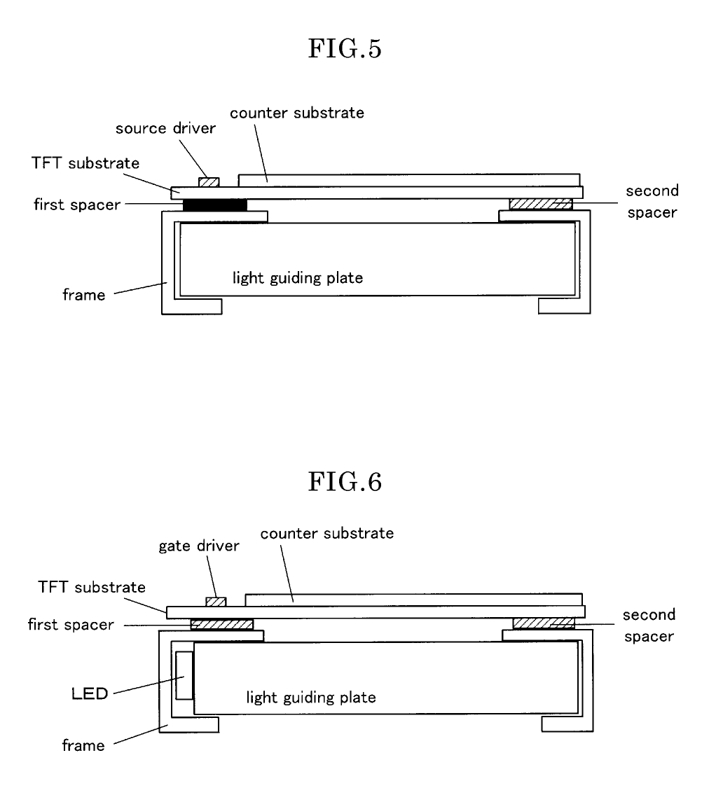

As shown in FIGS. 4 to 6, the liquid crystal display device according to the present invention has a TFT substrate, a counter substrate facing the TFT substrate, a liquid crystal display panel where liquid crystal is sealed between the TFT substrate and the counter substrate, and a backlight for illuminating the liquid crystal display panel with illumination light, and is characterized in that source drivers and gate drivers for driving the liquid crystal display panel are mounted on the TFT substrate, and thermally conductive spacers (first spacers, see FIG. 5) are provided to the portions of the rear surface of the TFT substrate that correspond to the portions on which the source drivers are mounted between the TFT substrate and the frame for supporting the backlight.

The TFT substrate is provided, for example, by forming pixel electrodes, wires and thin film transistors, which are switching elements for driving the pixel electrodes, on a glass substrate. In addition, the counter substrate is provided, for example, by forming color filters on a glass substrate.

Scanning signal lines and video signal lines are connected to the thin film transistors. In order to drive the liquid crystal display panel having the thin film transistors in it, gate drivers for controlling scanning signals that are supplied to the scan signal lines and source drivers for controlling video signals that are supplied to the video signal lines are provided the TFT substrate. As for the method for providing and fixing the drivers, the COG mounting method is adopted.

In addition, a backlight for illuminating the liquid crystal display portion is provided to the rear surface of the liquid crystal display panel. The backlight is formed of a number of LEDs (light emitting elements) as the light source, a light guiding plate for guiding the light from the light source throughout the entirety of the display region, and an optical sheet (not shown), such as a diffusion sheet or a prism sheet, for making the intensity of the illumination of light emitted from the light guiding plate uniform throughout the entirety of the display region, for example. FIG. 4 shows the region where LEDs are aligned as an LED aligned region surrounded by a dotted line. As shown in FIG. 6, the LEDs are aligned and secured to the side of the light guiding plate. In addition, the backlight, which includes the light source and the light guiding plate, is supported by a frame made of a metal.

The liquid crystal display device according to the present invention is characterized by the structure having high effects of heat release from the source drivers mounted on the TFT substrate that emit a large amount of heat. Concretely, thermally conductive spacers (first spacers) are provided between the frame for supporting the TFT substrate and the TFT substrate so as to face the source drivers. In the conventional liquid crystal display devices, spacers having a low thermal conductance, for example, spacers made of relatively soft foam insulators, are used in order to prevent the heat emitted from the light source in the backlight from being conveyed to the liquid crystal display panel or the driver as much as possible. In the liquid crystal display device according to the present invention, the spacers provided to the locations facing the source drivers that emit a significant amount of heat are thermally conductive spacers having high thermal conductance, and thus the heat generated by the source drivers is efficiently released to other members, such as the frame.

Various types of thermally conductive materials, for example, silicon-based or graphite-based materials, can be used for the thermally conductive spacers. Here, it is preferable for the material to have air tightness and elasticity in order for the spacers to have their original functions of holding the liquid crystal display panel and the backlight with a space in between and preventing the liquid crystal display panel from deforming.

It is preferable for the thermal conductance of the thermally conductive spacers used in the present invention to be 0.5 W/m·K or higher. In the case where the thermal conductance is less than this, it is necessary to increase the thickness of the spacers and the contact area between the spacers and the TFT substrate in order to expect a sufficient effect of heat release, which may cause such a problem that the thickness of the liquid crystal display device or the area of the frame portion may increase. When thermally conductive spacers having a thickness of 2.5 mm are aligned along one side of the TFT substrate on which the source drivers are provided in the portion shown in FIG. 4 as the thermally conductive spacer region, the effects of reducing the temperature of the heat emitted from the semiconductor chips by approximately 10° C. at maximum can be gained.

The spacers provided between the TFT substrate and the frame are usually aligned along the four sides of the TFT substrate and are connected or separated. In the liquid crystal display device according to the present invention, the spacers provided to the locations facing the source drivers are thermally conductive spacers as in the first embodiment shown in FIGS. 4 to 6. Here, thermally conductive spacers are hard in comparison with the spacers formed of foam insulators that are used in the prior art. Accordingly, it is desirable for the spacers provided in other locations (second spacers) to be spacers formed of relatively soft foam insulators in order to prevent the liquid crystal display panel from deforming.

At this time, as shown in FIG. 4, it is desirable for the LED aligned region to be provided along a side of the liquid crystal display panel different from the side along which the source drivers are aligned. In FIG. 4, the LED aligned region is formed along the side along which the gate drivers are aligned.

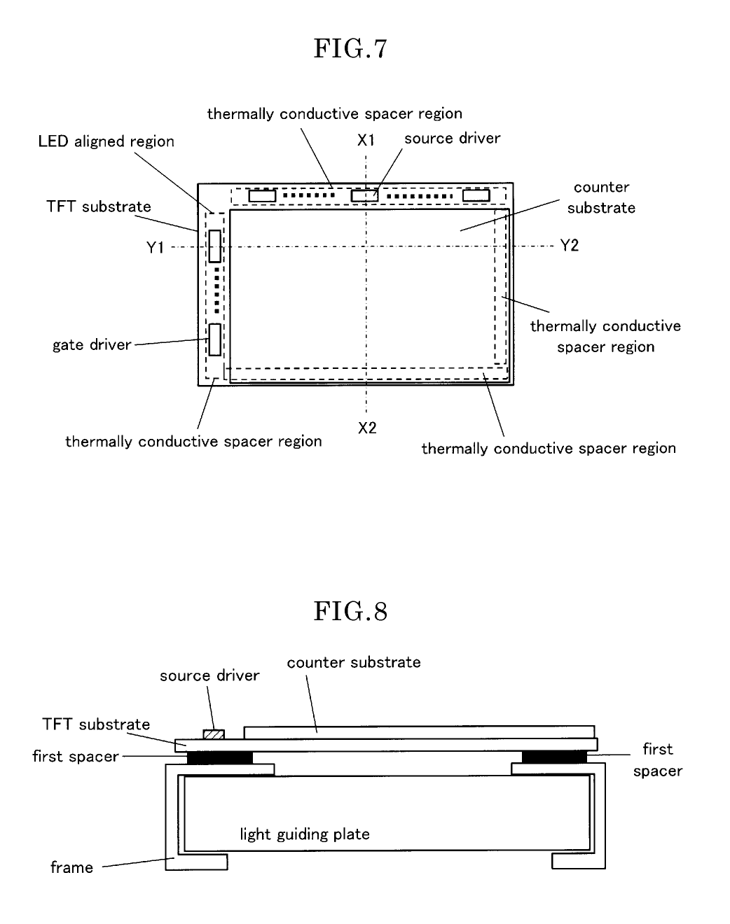

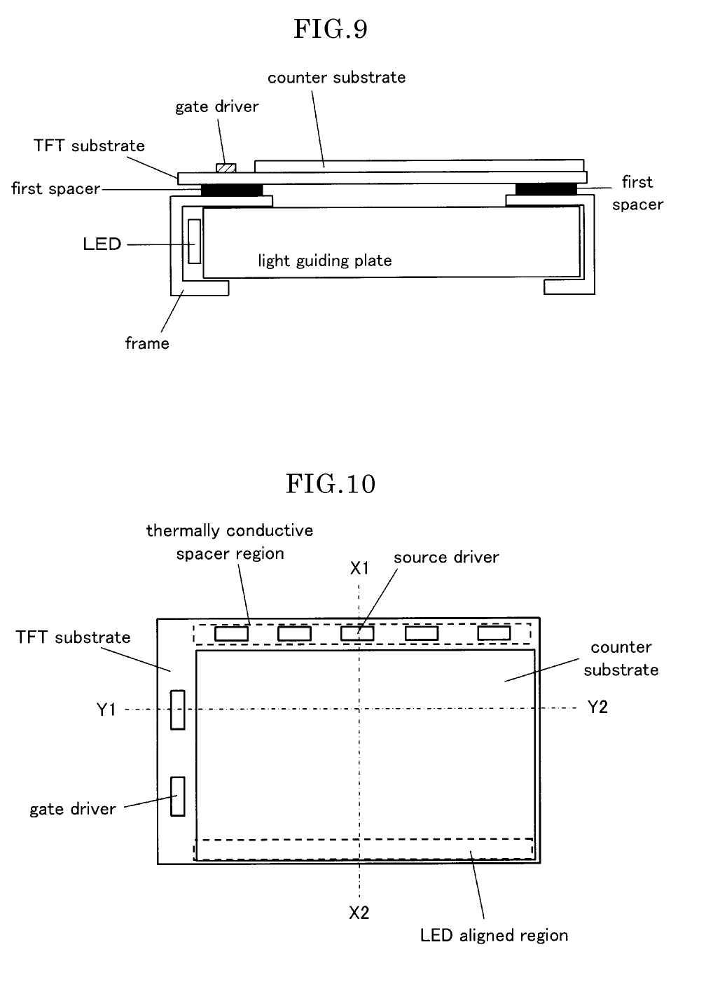

FIGS. 7 to 9 are diagrams illustrating the second embodiment of the present invention. As shown in FIGS. 7 to 9, it is possible to substitute all the spacers with thermally conductive spacers (first spacers). When all the spacers along the four sides are formed of the same material, stress applied to the liquid crystal display panel can be made even, and thus inconsistency in the display can be prevented from being caused due to the application of stress in a local area on the liquid crystal display panel.

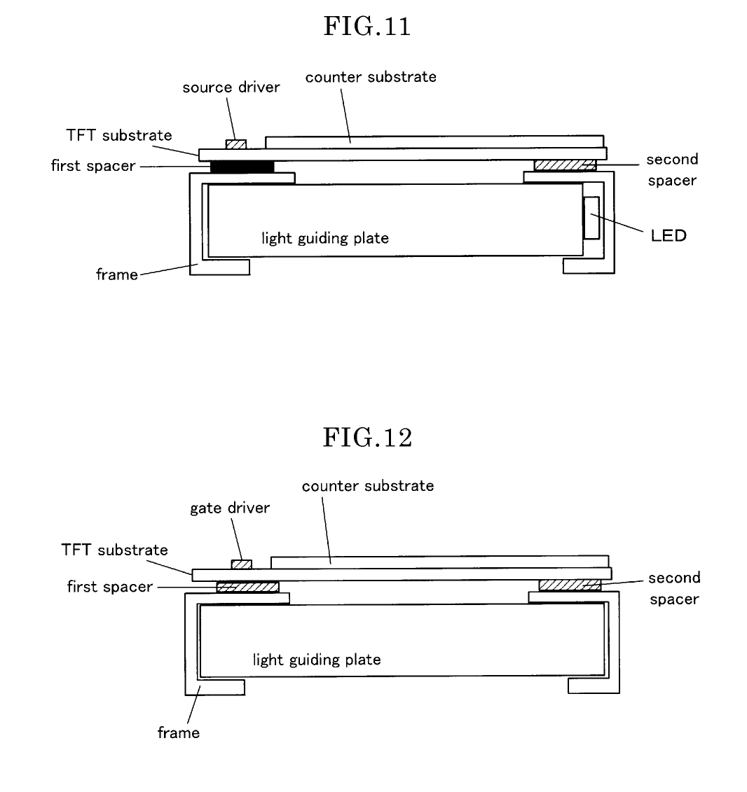

FIGS. 10 to 12 are diagrams illustrating the third embodiment of the present invention. As shown in FIGS. 10 to 12, the LED aligned region is provided along a side that is different from the side along which the source drivers are aligned and is also different from the side along which the gate drivers are aligned. The drivers, which are the sources of the emission of heat, and the LEDs are separated so that no local area has a high temperature, and thus it is possible to provide a liquid crystal display device having high reliability.

Furthermore, the frame for supporting the backlight is provided with fixtures for the attachment to the main frame or the housing of the liquid crystal display device. When the thermally conductive spacers are placed in proximity to these fixtures, the heat that has been conveyed to the frame can further be released to the main frame or the housing efficiently, and thus it is possible to further enhance the effects of heat release.

As described above, the present invention makes it possible to provide a liquid crystal display device having a large screen, high resolution and high reliability at the same time, even in the case where drivers are mounted on a TFT substrate in accordance with the COG mounting method.

What is claimed is:

1. A liquid crystal display device, comprising: a TFT substrate where thin film transistors are formed; a counter substrate that faces said TFT substrate; a liquid crystal display panel where liquid crystal is sealed between said TFT substrate and said counter substrate; a backlight which illuminates said liquid crystal display panel with light; and a frame which supports said liquid crystal display panel, wherein
scanning signal lines and video signal lines are formed on said TFT substrate, semiconductor chips connected to said video signal lines are provided to said TFT substrate,
said semiconductor chips are placed along a first side of said TFT substrate,
a first spacer is provided in a location that faces said semiconductor chip as viewed in a plane between said first side of said TFT substrate and said frame, and
a second spacer of which a thermal conductance is lower than said first spacer is provided between said frame and a second side of said TFT substrate, the second side being different from said first side.

2. The liquid crystal display device according to claim 1, wherein the thermal conductance of said first spacer is 0.5 W/m·K or higher.

3. The liquid crystal display device according to claim 1, wherein a material of said first spacer includes silicon or graphite.

4. The liquid crystal display device according to claim 1, wherein said second spacer is formed of a foam insulator.

5. The liquid crystal display device according to claim 1, wherein
said backlight has light emitting elements and a light guiding plate,
said light emitting elements are aligned along one side of said light guiding plate, and
said one side of said light guiding plate faces said second side of said TFT substrate.

6. The liquid crystal display device according to claim 5, wherein
gate drivers connected to said scan signal lines are provided to said TFT substrate, and
said gate drivers are aligned along a side of said TFT substrate that faces said one side of said light guiding plate.

7. The liquid crystal display device according to claim 5, wherein
said second side of said TFT substrate is parallel to said first side of said TFT substrate.

8. The liquid crystal display device according to claim 5, wherein
said light emitting elements are a number of light emitting diodes.

9. A liquid crystal display device, comprising: a TFT substrate where thin film transistors are formed; a counter substrate that faces said TFT substrate; a liquid crystal display panel where liquid crystal is sealed between said TFT substrate and said counter substrate; a backlight which illuminates said liquid crystal display panel with light; and a frame which supports said liquid crystal display panel, wherein
scanning signal lines and video signal lines are formed on said TFT substrate, semiconductor chips connected to said video signal lines are provided to said TFT substrate,
spacers having a thermal conductance of 0.5 W/m·K or higher are provided between the sides of said TFT substrate and said frame,
said semiconductor chips are aligned along a first side of said TFT substrate and face a spacer as viewed in a plane,
said backlight has light emitting elements and a light guiding plate,
said light emitting elements are aligned along one side of said light guiding plate, and
said one side of said light guiding plate faces a second side of said TFT substrate, the second side being different from said first side.

10. The liquid crystal display device according to claim 9, wherein a material of said spacers includes silicon or graphite.

11. The liquid crystal display device according to claim 9, wherein
gate drivers connected to said scanning signal lines are provided to said TFT substrate, and
said gate drivers are aligned along a side of said TFT substrate that faces said one side of said light guiding plate.

12. The liquid crystal display device according to claim 9, wherein said light emitting elements are a number of light emitting diodes.
